(19) United States
(12) Patent Application Publication
(10) Pub. No.: US 2004/0015259 A1
(43) Pub. Date: Jan. 22, 2004

(54) NC machining program having easily selectable modes

(76) Inventors: A-Po Tsai, Chong Ho City (TW); Tung Po Liu, Chong Ho City (TW)

Correspondence Address: A-Po TSAI, Tung Po LIU, P.O.Box 10-69, Chong Ho, Taipei, 235, TW

(21) Appl. No.: 10/199,810

(22) Filed: Jul. 18, 2002

(51) Int. Cl. G06F 19/00

(52) U.S. Cl. 700/181

(57) ABSTRACT

A machining program of a machine includes a number of machining modes, and a number of other or different machining modes, to be selected by users and to be conducted by the machine to work on work pieces at any time without stopping the machine. The machining modes may be shown in a screen and to be easily selected by the users, and may be the multi-slot or single slot modes, or the surface modes, and may be pre-programmed, for allowing the users to easily select and change to conduct the required machining modes without writing further programs while working the work pieces.

### BACKGROUND OF THE INVENTION

1. Field of the Invention

The present invention relates to an NC machine, and more particularly to an NC machine including an NC machining program having a number of modes that may be easily selected and conducted by the NC machine at any time without stopping the machine.

2. Description of the Prior Art

Various kinds of typical NC machines have been developed and provided for conducting various kinds of machining or working operations. U.S. Pat. No. 5,392,502 to Freer, U.S. Pat. No. 5,439,328 to Haggerty et al., U.S. Pat. No. 5,610,842 to Seki et al., U.S. Pat. No. 5,862,056 to Iwata et al., U.S. Pat. No. 5,886,319 to Preston et al., and U.S. Pat. No. 6,073,058 to Cossen et al. disclose several of the conventional NC machines.

The conventional NC machines comprise a screen for displaying the working operations or the working modes to be worked or conducted with the NC machines. However, normally, the NC machining program of the NC machines should be programmed or preset before the NC machines may be energized or worked.

In addition, once the NC machining program of the NC machines has been set or determined, the NC machine program may not be changed or adjusted until the works or operation of the NC machines have been completed.

In order to change or to adjust the NC machining program of the NC machines, the NC machines should be switched off or should be stopped before the NC machine program may be changed or adjusted. This is inconvenient.

The present invention has arisen to mitigate and/or obviate the afore-described disadvantages of the conventional NC machines.

### SUMMARY OF THE INVENTION

The primary objective of the present invention is to provide an NC machines including an NC machining program having a number of modes that may be easily selected and conducted by the NC machine at any time, without stopping the machine.

The other objective of the present invention is to provide an NC machines including an NC machining program having a number of modes that may be randomly selected and changed to actuate the NC machine to conduct different or changing working or machining modes onto the work pieces.

The further objective of the present invention is to provide an NC machines including an NC machining program having a number of modes that have been predetermined or pre-programmed, for allowing the users to easily select and change to conduct the required working or machining modes without writing or entering programs.

In accordance with one aspect of the invention, there is provided a machining program of a machine comprising a number of first machining modes, and a number of second machining modes, to be selected by users and to be conducted by the machine to work on work pieces at any time without stopping the machine.

A screen may further be provided and having the first and the second machining modes shown in the screen.

The first and the second machining modes may be the multi-slot modes, the single slot modes, or the surface modes.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan schematic view illustrating a screen of an NC machine in accordance with the present invention having a number of modes that may be easily selected and conducted by the NC machine;

FIG. 2 is a block diagram illustrating the operation or the working processes of the NC machine;

FIG. 3 is a schematic view illustrating a work piece to be worked or machined with the selected modes of the NC machining program of the present invention;

3 and

FIGS. 4, 5, 6, 7, 8 are schematic views similar to FIG. 3, illustrating various work pieces to be worked or machined with the selected modes of the NC machining program of the present invention.

### DETAILED DESCRIPTION OF THE PREFERRED EMBODIMENT

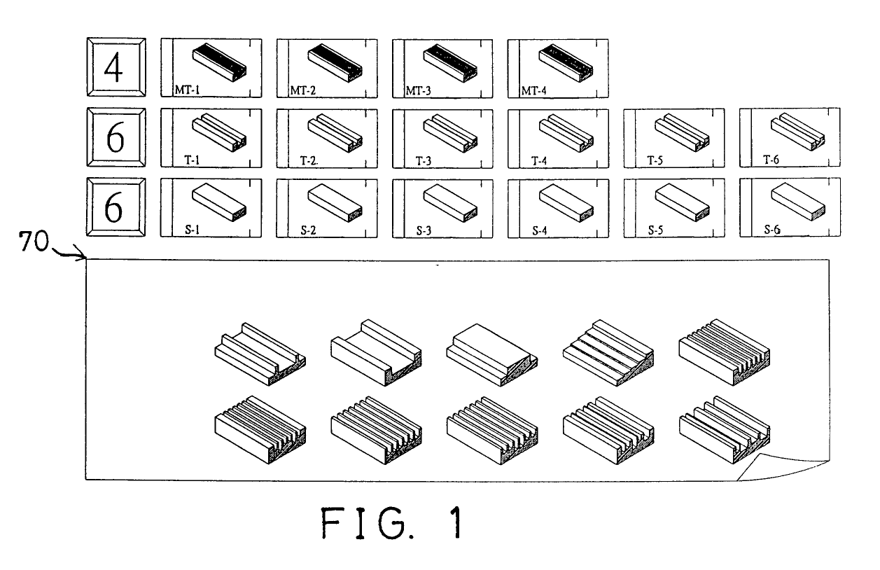

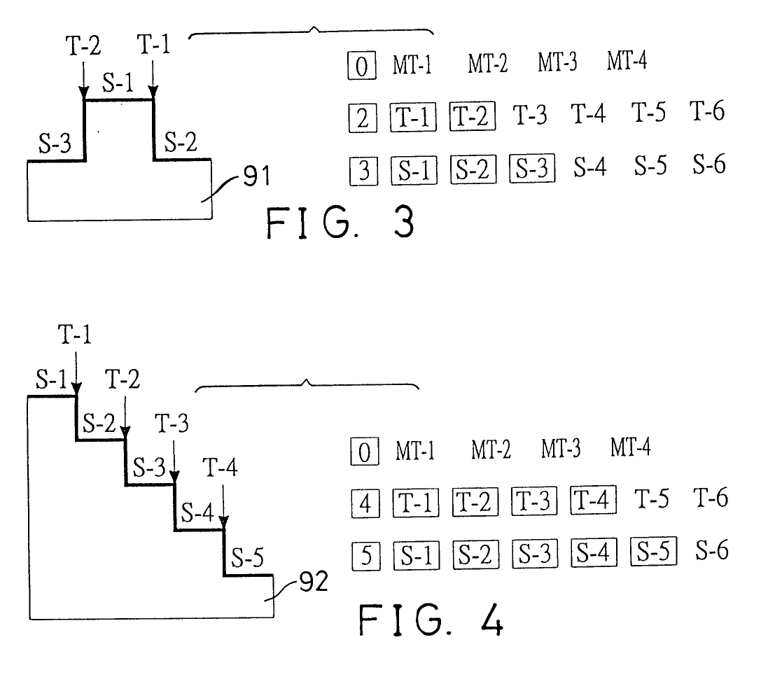

Referring to the drawings, and initially to FIG. 1, an NC machine in accordance with the present invention comprises a screen 70, and a machining program, such as an NC machining program for controlling the NC machine to machine or to work onto various objects or work pieces 91-96 (FIGS. 3-8).

The NC machining program of the NC machine includes a number of working or machining modes predetermined or pre-programmed and provided on the screen 70.

For example, the NC machining program of the NC machine includes four (4) different first modes, such as four multi-slot modes MT-1, MT-2, MT-3, MT-4, and six (6) second modes, such as single-slot modes T-1, T2, T-3, T-4, T-5, T-6, and six (6) third modes, such as surface modes S-1, S-2, S-3, S-4, S-5, S-6 shown in the screen 70.

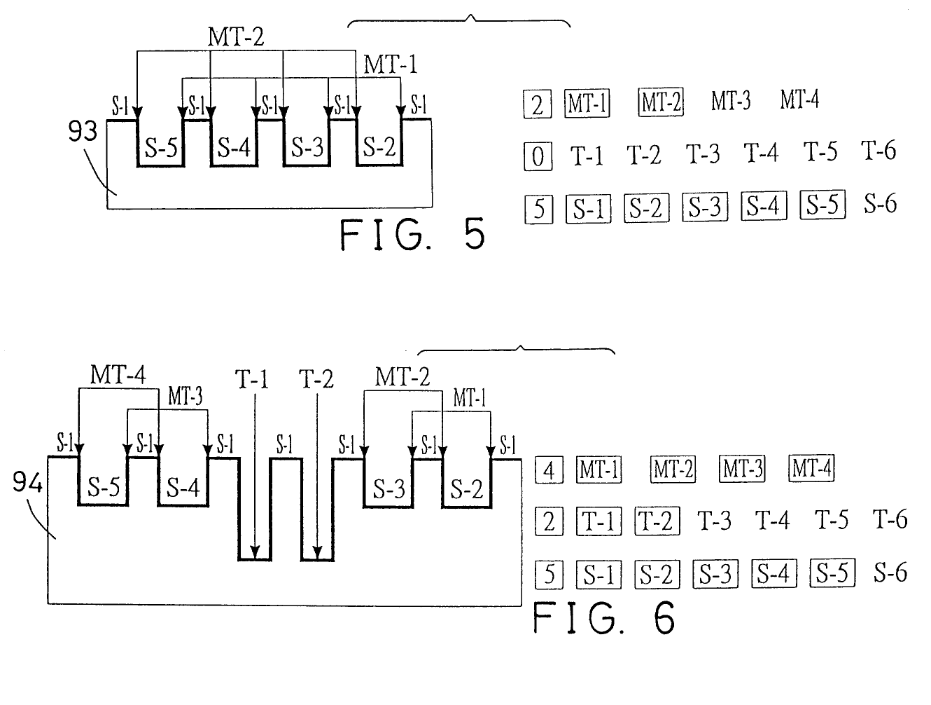

The multi-slot modes MT-1, MT-2, MT-3, MT-4, may be pre-programmed and provided for machining different number of slots that may have different widths, heights, etc., in the work pieces 93-96 (FIGS. 5-8).

The single-slot modes T-1, T-2, T-3, T-4, T-5, T6, may be pre-programmed and provided for machining a single slot having different widths, heights, etc., in each of the work pieces 91, 92 and 94-96 (FIGS. 3, 4, and 6-8).

The surface modes S-1, S-2, S-3, S-4, S-5, S-6, may be pre-programmed and provided for machining various surfaces in the work pieces 91-96 (FIGS. 3-8), for example.

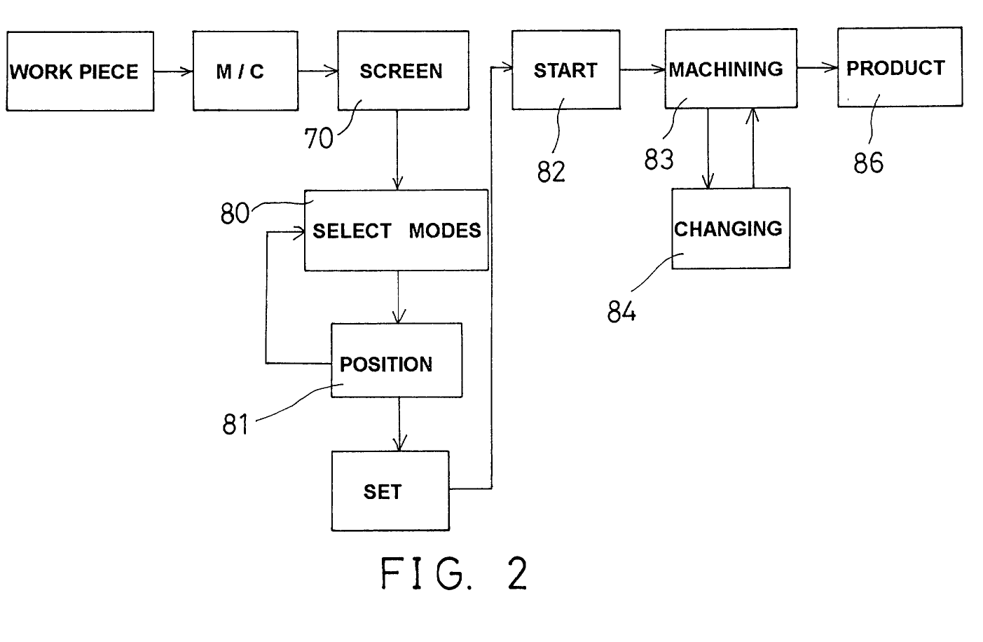

In operation, as shown in FIG. 2, the screen 70 of the machine may show various kinds of modes MT-1-4, T1-6, and S-1-6, that may be selected by the users in the process 80. The work pieces may then be positioned to the machine at the required positions in the process 81, until the required modes have been selected, and the work pieces have been positioned to the machine at the predetermined position.

The machine may then be started in the process 82, in order to machine the work pieces in the process 83. While the machine is working, the working or machining modes may also be changed or selected or amended at any time without stopping the machine, in the process 84, until the product 86 has been worked or completed.

Referring next to FIG. 3, for example, two of the single-slot modes T-1, T-2, and three of the surface modes S-1, S-2, S-3, may be selected to machine two single slots and three surfaces in the work piece 91.

Referring next to FIG. 4, four of the single-slot modes T-1, T-2, T-3, T-4, and five of the surface modes S-1, S-2, S-3, S-4, S-5, may be selected to machine four single slots and five surfaces in the work piece 92.

Referring next to FIG. 5, two of the multi-slot modes MT-1, MT-2, and five of the surface modes S-1, S2, S-3, S-4, S-5 may be selected to machine two multi-slots and five surfaces in the work piece 93.

Referring next to FIG. 6, four of the multi-slot modes MT-1, MT-2, MT-3, MT-4, and two of the single-slot modes T-1, T-2, and five of the surface modes S-1, S-2, S-3, S-4, S-5 may be selected to machine four multi-slots, two single slots and five surfaces in the work piece 94.

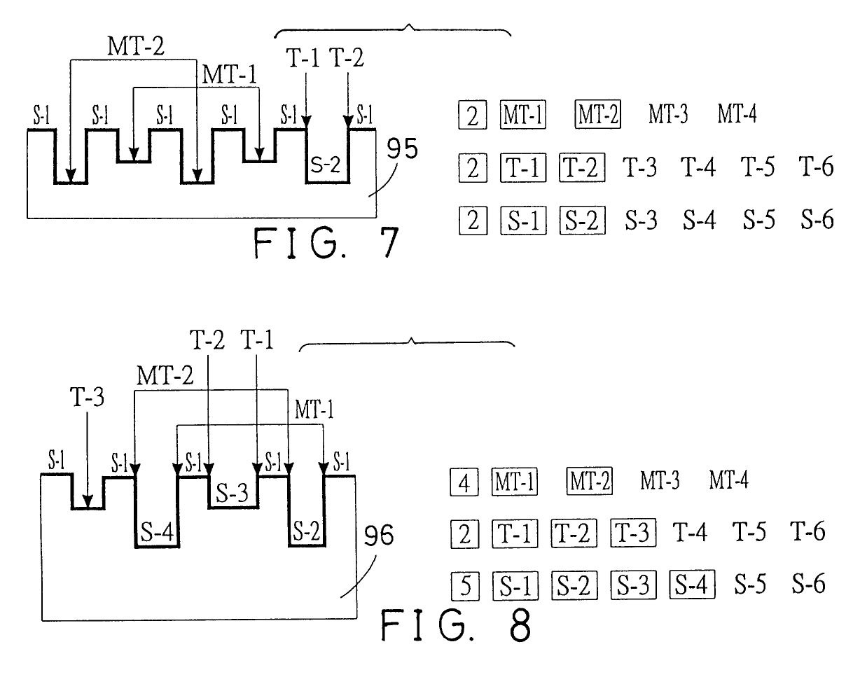

Referring next to FIG. 7, two of the multi-slot modes MT-1, MT-2, and two of the single-slot modes T-1, T-2, and two of the surface modes S-1, S-2, may be selected to machine two multi-slots, two single slots and two surfaces in the work piece 95.

Referring next to FIG. 8, two of the multi-slot modes MT-1, MT-2, and three of the single-slot modes T1, T-2, T-3, and four of the surface modes S-1, S-2, S3, S-4, may be selected to machine two multi-slots, three single slots and four surfaces in the work piece 96.

It is to be noted that the modes selected and shown in FIGS. 3-8 are provided for illustrating purposes only. The various kinds of modes of the NC machining program of the NC machine may be randomly or optionally selected to machine or to work onto various objects or work pieces. In addition, the NC machining program of the NC machine may also include the other working or machining modes, such as the drilling modes, the curving modes, the rounding modes, etc.

Furthermore, the machining or the working modes are predetermined or pre-programmed, for allowing the users to easily select and change to conduct the required working or machining modes without-writing or entering programs while working the work pieces.

Accordingly, the NC machines in accordance with the present invention includes an NC machining program having a number of modes that may be easily selected and conducted by the NC machine at any time without stopping the machine.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A machining program of a machine comprising:
a plurality of first machining modes, and
a plurality of second machining modes, to be selected by users to work on work pieces.

2. The machining program according to claim 1 further comprising a screen having said first and said second machining modes shown in said screen.

3. The machining program according to claim 1, wherein said first machining modes are multi-slot modes.

4. The machining program according to claim 1, wherein said first machining modes are single slot modes.

5. The machining program according to claim 1, wherein said first machining modes are surface modes.

6. The machining program according to claim 1, wherein said second machining modes are multi-slot modes.

7. The machining program according to claim 1, wherein said second machining modes are single slot modes.

8. The machining program according to claim 1, wherein said second machining modes are surface modes.
